(19) United States
(12) Patent Application Publication
(10) Pub. No.: US 2019/0367314 A1
(43) Pub. Date: Dec. 5, 2019

(54) IMAGE FORMING APPARATUS WITH DIVERTING MECHANISM AND METHOD FOR DIVERTING IMAGE RECEIVING MEDIUM

(71) Applicant: TOSHIBA TEC KABUSHIKI KAISHA, Tokyo (JP)

(72) Inventor: Masaki OKAWARA, Mishima Shizuoka (JP)

(21) Appl. No.: 16/211,841

(22) Filed: Dec. 6, 2018

Related U.S. Application Data
(63) Continuation of application No. 15/996,961, filed on Jun. 4, 2018, now abandoned.

(51) Int. Cl. B65H 29/62; B41J 11/00; G03G 15/00

(52) U.S. Cl. CPC B65H 29/62; B41J 11/006; G03G 15/70; G03G 15/6511; B65H 2513/42; B65H 2513/41; B65H 2601/11; B65H 2511/528; B65H 2511/522

(57) ABSTRACT

An image forming apparatus has an image forming section configured to form an image on an image receiving medium conveyed along a conveyance path from a cassette thereto, a diverted conveyance path connected to the conveyance path at a first point on the conveyance path upstream of the image forming section, a movable guide that is controlled to guide the image receiving medium along a first path that includes a second point on the conveyance path downstream of the first point or a second path that includes the diverted conveyance path, a group of sensors positioned to detect at least two positions of a leading edge of the image receiving medium before the image receiving medium is guided by the movable guide, and a controller configured to control the movable guide to guide the image receiving medium along the first or second path based on detection results of the sensors.

### CROSS-REFERENCE TO RELATED APPLICATION

This application is a continuation of U.S. patent application Ser. No. 15/996,961, filed on Jun. 4, 2018, the entire contents of each of which are incorporated herein by reference.

### FIELD

Embodiments described herein relate generally to an image forming apparatus provided with a diverting mechanism which detects skew and corner fold of an image receiving medium being conveyed and then diverts the image receiving medium from a conveyance route, and a method for diverting an image receiving medium.

### BACKGROUND

Generally, an image forming apparatus sequentially picks up a plurality of image receiving media from a media cassette one by one and then sequentially supplies them to a recording head through a conveyance route. Furthermore, the image receiving media on which an image is formed by the recording head are sequentially discharged onto a tray from a discharge port through the conveyance route. A plurality of sensors is arranged at plural positions in the conveyance route to monitor whether or not the image receiving media are properly conveyed based on information detected by the sensors.

In a typical media cassette, a guide is arranged to pick up the image receiving medium one by one in a proper orientation. The guide is moveable so as to easily replenish the image receiving media and handle image receiving media of different sizes. Therefore, it is necessary to set the guide to a proper position at the time of replenishing the image receiving media. When the setting of the guide is forgotten or has failed, there is likely to be a gap between the image receiving media and the guide, leading to failure in regulating the position of the image receiving media in the cassette. For this reason, there is a possibility that the image receiving media are not properly aligned in the media cassette due to vibration during an operation of the image forming apparatus. For example, if the entire image receiving media is misaligned with respect to the pickup direction, an image receiving medium is obliquely picked up by a pickup roller and then is conveyed obliquely in the conveyance route, i.e., in a so-called skew state. At this time, if the image receiving medium abuts against any component located on a sidewall of the conveyance route, a jam of the image receiving medium may occur in the conveyance route due to folding or wrinkling of a corner of the image receiving medium, and an image forming job is interrupted due to a conveyance error. If the image receiving medium is slightly skewed, i.e., in a state in which the inclination thereof is slight, the skew of the image receiving medium may be corrected by a registration roller. However, if the skew of the image receiving medium cannot be corrected, the image receiving medium is conveyed in the skewed state, which is an important factor causing the jam. Unless the cassette guide is placed into the proper position, the jamming caused by misalignment of the image receiving medium in the medium cassette continues during the conveyance of additional image receiving medium in the skewed state.

In the case of an image forming job requiring continuous image formation on a plurality of image receiving media, there are plural image receiving media on the conveyance route. For this reason, even if the jam of one image receiving medium among the plural image receiving media occurs in one place, it is necessary to detach a cover of the apparatus to remove all of the plural image receiving media from the conveyance route, which takes much time and labor. The image receiving media removed from the conveyance route because of the jam often cannot be reused due to breakage, a corner fold or wrinkle.

### DESCRIPTION OF THE DRAWINGS

FIG. 1 is a conceptual sectional diagram illustrating the overall configuration example of an image forming apparatus according to a first embodiment;

FIG. 2A is a diagram conceptually illustrating an example of a diverting mechanism for an image receiving medium;

FIG. 2B is a diagram conceptually illustrating an example of a diverting mechanism for an image receiving medium as a modification;

FIG. 3 is a diagram illustrating a block configuration of the image forming apparatus;

FIG. 4 is a diagram illustrating an example of a detection signal output from a sensor provided in the diverting mechanism for the image receiving medium;

FIG. 5 is a diagram depicting a diverting operation of the image receiving medium which is skewed or folded at a corner in the image forming apparatus;

FIG. 6 is a flowchart depicting image formation including the diverting operation of the image receiving medium in the image forming apparatus; and

FIG. 7 is a flowchart depicting an image forming example including a diverting operation of an image receiving medium in an image forming apparatus according to a second embodiment.

### DETAILED DESCRIPTION

Embodiments provide an image forming apparatus that can divert an image receiving medium which is skewed with respect to the conveyance path direction, or is folded at its corner, from the conveyance route at an initial stage of the conveyance thereof, to reduce the occurrence of the jam and without wastefully consuming the image receiving media.

Hereinafter, embodiments will be described in detail with reference to the accompanying drawings.

In accordance with an embodiment, an image forming apparatus comprises an image forming section configured to form an image on an image receiving medium that is conveyed along a conveyance path from a cassette to the image forming section, a diverted conveyance path connected to the conveyance path at a first point on the conveyance path that is upstream of the image forming section, a movable guide that is controlled to guide the image receiving medium along a first path that includes a second point on the conveyance path that is downstream of the first point on the conveyance path or a second path that includes the diverted conveyance path, a group of sensors positioned to detect at least two positions of a leading edge of the image receiving medium before the image receiving medium is guided by the movable guide, and a controller configured to control the movable guide to guide the image receiving medium along the first path or the second path based on detection results of the sensors.

### First Embodiment

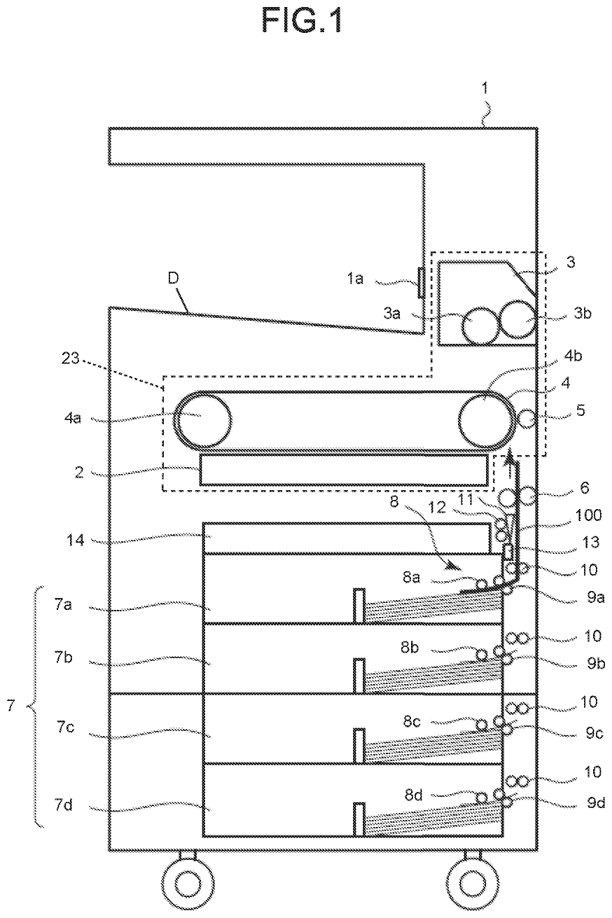

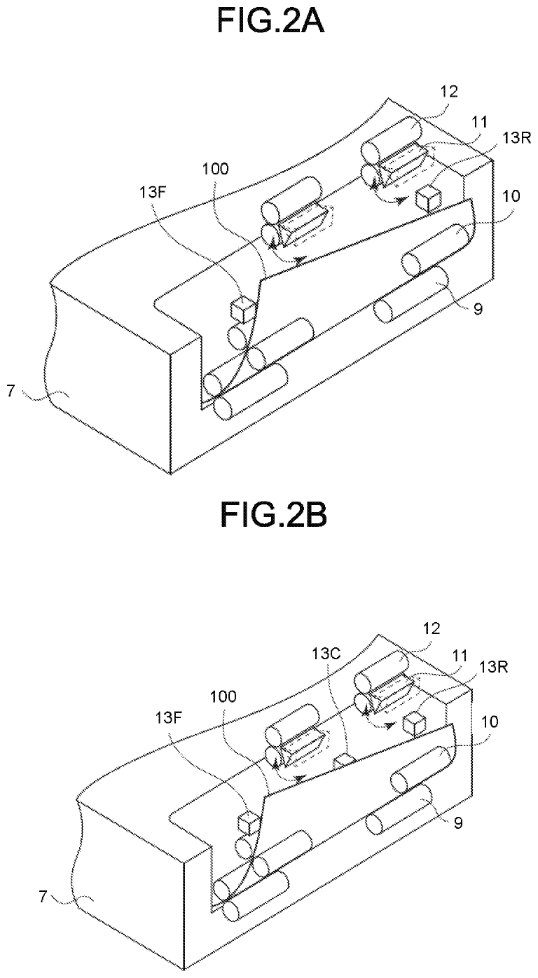

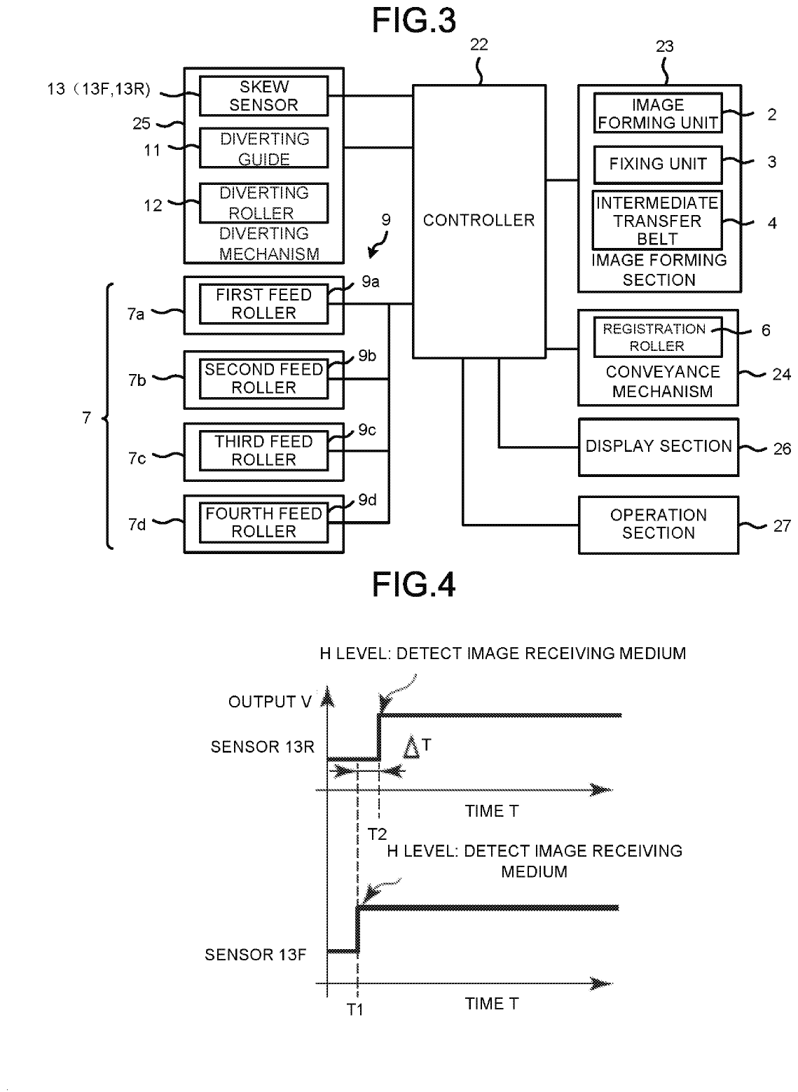

FIG. 1 is a conceptual sectional diagram illustrating the overall configuration example of an image forming apparatus according to the first embodiment. FIG. 2A is a diagram conceptually illustrating an example of a diverting mechanism for the image receiving medium, and FIG. 3 is a diagram illustrating a block configuration example of the image forming apparatus. With reference to these FIG. 1 to FIG. 3, the configuration of an image forming apparatus 1 is described.

The image forming apparatus 1 generally includes an image forming section 23, a conveyance mechanism 24, a media cassette 7, a controller 22, a diverting mechanism 25, a display section 26, and an operation section 27.

The controller 22 controls the entire image forming apparatus 1. The controller 22 is a hardware processor and includes an arithmetic processing unit (e.g., CPU), a storage section, a communication interface, and the like. For example, the storage section stores programs necessary for control of the image forming apparatus 1, operation guide information, and maintenance information for image receiving media jams. Furthermore, the controller 22 determines whether or not an image receiving medium 100 is skewed, or folded at a corner thereof, based on a signal output from a sensor and instructs the diverting mechanism. 25 described later to divert the image receiving medium 100 from the conveyance route.

For example, the image forming section 23 has an image forming unit 2 composed of a plurality of photoconductive drums and an optical system to form images for respective colors, an intermediate transfer belt 4 on which an image to be transferred to an image receiving medium 100 is formed by the image forming unit 2, a transfer roller 5 for pressing the image receiving medium. 100 against the intermediate transfer belt 4 to transfer an image thereto, and a fixing unit 3 for fixing the image transferred onto the image receiving medium 100. The image forming section 23 of the present embodiment is merely an example, and an image forming system thereof is not limited to the above example. For example, the image forming section 23 may form an image by a thermal transfer system or an inkjet system.

The intermediate transfer belt 4 is an endless belt around a driving roller 4a and a driven roller 4b and rotates, and thus, images separated by each color are transferred from the image forming unit 2 onto an outer circumferential surface of the intermediate transfer belt 4. The fixing unit 3 includes a heat roller 3a and a pressure roller 3b, and heats the image receiving medium 100 passing between the rollers, for example, at 100 degrees centigrade to fix the image onto the image receiving medium 100.

In this example, the media cassette 7 includes four media cassettes 7a, 7b, 7c, and 7d stacked in a vertical direction. In each media cassette 7, a known guide, which guides a side edge of the image receiving medium for controlling a pickup orientation of the image receiving medium 100 is provided. If the image receiving medium is placed on a manual feed tray in addition to the media cassettes 7, and a moveable guide is provided to align the side surface of the media in the manual feed tray. The guide is moveable and moves to facilitate storage of the image receiving medium, i.e. enable the cassettes 7a-7d or manual feed tray handle image receiving media of plural different sizes, thereby bringing versatility of use to the media cassette 7 and manual feed tray. For example herein, among these plurality of media cassettes 7a to 7d, the image receiving media 100 accommodated in the media cassette 7a and the media cassette 7b are the same as each other, i.e., they have the same sizes (e.g., A4 size), and the image receiving media 100 accommodated in the media cassettes 7c and 7d are accommodated in combination of mutually different sizes (e.g., B5, B4 sizes, each in a different cassette), and the desired size of media for image transfer thereto can be properly selected by a user at the time of forming an image. Furthermore, a media cassette which has no guide and can accommodate only an image receiving medium 100 of a specific size can be applied.

The conveyance mechanism 24 picks up the image receiving medium 100 from one of the media cassettes 7a to 7d and then conveys it to an image receiving medium discharge port 1a to discharge the image receiving medium onto a discharging tray D via the intermediate transfer belt 4 and the fixing unit 3. The conveyance mechanism 24 includes pickup rollers 8 (e.g., 8a, 8b, 8c and 8d) provided for individual media cassettes 7a to 7d, feed rollers 9 (e.g., a first feed roller 9a, a second feed roller 9b, a third feed roller 9c, and a fourth roller 9d) for feeding the image receiving medium 100 to the conveyance route, and conveyance rollers 10 arranged on the conveyance route. Furthermore, a registration roller 6 is arranged on the upstream side of the intermediate transfer belt 4 in the conveyance route. If the inclination of the image receiving medium 100 falls within a preset correction range, the registration roller 6 abuts against the leading edge of the image receiving medium 100 to correct the image receiving medium 100 and the controller 22 sets the timing of delivery to the intermediate transfer belt 4.

The display section 26 is provided on an upper surface of a main body of the apparatus. The display section 26 is a liquid crystal display panel or the like, and displays various items such as information about a state (e.g., a preparation state, a sleep state, etc.) of the image forming apparatus, a setting item of image formation, progress status of the image formation, a warning display, a conveyance error report and maintenance information.

The operation section 27 is provided on the upper surface of the main body of the apparatus. The operation section 27 is provided with a plurality of functional keys and numeric keys, and an operation for setting relating to the image formation and an operation for confirmation are performed. The operation section 27 may be a touch panel arranged on the upper surface of the display section 26. The operation section 27 may be a combination of a touch panel and keys.

The diverting mechanism 25 is constituted by a diverting guide 11, a diverting roller 12, a skew sensor 13, and a diverting tray 14, and the diverting mechanism 25 forms a diverting conveyance route which branches from the conveyance route to convey the image receiving medium 100 at a branch point located at an upstream side in the initial stage of the conveyance route.

The skew sensor 13 is an optical sensor that optically detects the skew state of the image receiving medium 100 being conveyed or the corner fold on the leading edge of the image receiving medium. The skew sensor 13 detects one side edge of the media which is the straight line on the leading edge of the image receiving medium 100 being conveyed. At least two skew sensors 13 (e.g., 13F and 13R) are arranged in a line in a direction perpendicular to the conveyance route. These skew sensors 13F and 13R are preferably arranged to detect the leading edge of the print media adjacent to the opposed sides of the media in the width direction of the image receiving medium (in a direction orthogonal to the conveyance direction) of the image receiving medium. However, if the skew sensor 13 detects sizes of the plurality of image receiving media, the skew sensor 13 is arranged in accordance with a width of the image receiving medium of the smallest size. In order to correctly detect the corner fold on the leading edge of the image receiving medium 100 as in a modification described later, three skew sensors 13 (e.g., 13F, 13R and 13C) may be arranged, two at the leading edge adjacent to the opposed sides of the media in the width direction and one centrally located with respect to those at the opposed sides of the media in the width direction.

The diverting tray 14 is a detachable storage tray arranged directly above the uppermost media cassette 7a and accommodates the diverted image receiving medium 100. The diverting tray 14 is not limited to being arranged in the main body of the apparatus, and it may be an externally attached tray.

As shown in FIG. 1, the diverting guide 11 is positioned to block an opening in the front of the diverting tray 14, and the lower side thereof can swing as shown in FIG. 2A. In response to the instruction from the controller 22, the diverting guide 11 is switched between a diverting mode of the image receiving medium 100 with a lower tip side thereof protruding to the conveyance route to guide an image receiving medium 100 toward the diverting tray 14 and a diverting standby mode with the lower tip side thereof diverting from the conveyance route to allow an image receiving medium 100 to be conveyed toward the registration roller 6.

The diverting roller 12 is arranged between the diverting guide 11 and the diverting tray 14 and feeds the image receiving medium 100 diverted from the conveyance route by the diverting guide 11 to the diverting tray 14. If the diverted image receiving medium 100 can be sent to the diverting tray by the conveyance roller 10, it is not necessary to provide the diverting roller 12.

In the present embodiment, as shown in FIG. 1, the diverting guide 11 and the diverting roller 12 are provided on the upstream side of the registration roller 6 in the conveyance route and are provided close to the first feed roller 9a of the uppermost media cassette 7a. Furthermore, as shown in FIG. 1, the diverting guide 11 and the diverting roller 12 are provided in the vicinity of the conveyance roller 10 located closest to the first feed roller 9a.

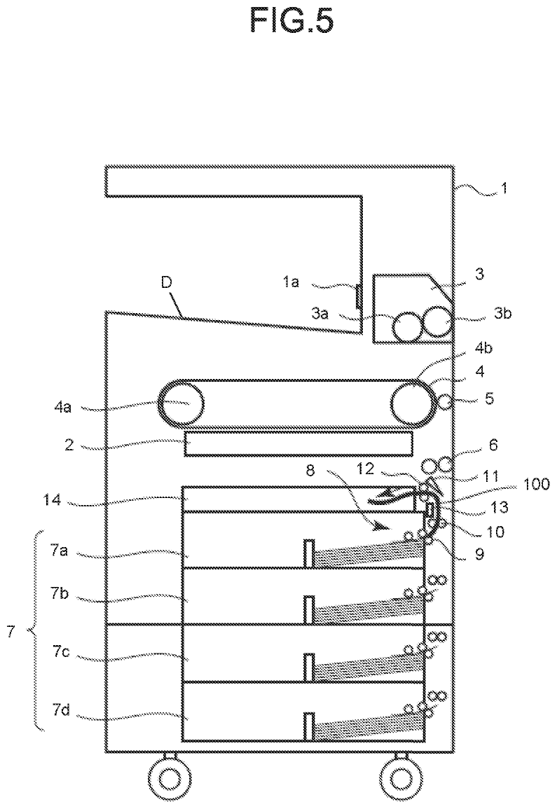

With reference to FIG. 4 and FIG. 5, the diverting operation of the image receiving medium 100 by the diverting mechanism 25 is described.

The image receiving medium 100 diverted from the normal conveyance route is an image receiving medium 100 which is obliquely conveyed or an image receiving medium 100 at which a fold occurs at a corner thereof on the leading edge, both of which may be abnormally conveyed due to a jam. When these image receiving media 100 are picked up by the pickup roller 8 from the media cassette 7, the skew or the corner fold has already occurred in many cases. It is possible to detect the skew and the corner fold at the time of being picked up from the media cassette 7.

In the present embodiment, two skew sensors 13 (e.g., 13F and 13R) are linearly arranged in the width direction of the image receiving medium 100 in the vicinity of the above-mentioned image receiving medium outlet of the media cassette 7. In the present embodiment, as shown in FIG. 2A, in the conveyance route of the image forming apparatus 1, the skew sensor 13F is located on the front side of the apparatus and the skew sensor 13R is located on the rear side of the apparatus. These skew sensors 13 are turned on immediately before the image receiving medium 100 passes them to output a preset predetermined output (e.g., H level).

FIG. 2A shows an example in which the image receiving medium 100 is picked up from the media cassette 7 in such a manner that the image receiving medium 100 has an inclination, i.e., a part on the front side of the apparatus of the image receiving medium 100 moves ahead of a part thereof on the rear side of the apparatus. As shown in FIG. 4, when the leading edge of the skewed image receiving medium 100 covers the skew sensors 13F and 13R, after the skew sensor 13F is first turned on at a time T1, the skew sensor 13R is then turned on at a time T2. If a time difference ΔT: |T1−T2|>0 occurs, the side which is the straight line on the leading edge side of the image receiving medium 100 does not pass through the skew sensors 13F and 13R at the same time. In other words, the controller 22 can determine that the image receiving medium 100 is skewed, i.e., a part thereof on the front side of the apparatus moves ahead, or that the corner fold occurs at a part thereof on the rear side of the apparatus.

With reference to FIG. 5, a diverting operation of the image receiving medium 100 is described.

As described above, the controller 22 determines that the image receiving medium 100 picked up from the media cassette 7a is skewed or folded at the corner thereof based on the detection signal output from the skew sensor 13. The controller 22 controls the diverting guide 11 to swing about a pivot point thereof based on the determination of the presence of the skew or the corner fold, which inserts the tip of the guide into the conveyance route, and guides the image receiving medium 100 conveyed by the conveyance roller 10 toward the diverting route. The image receiving medium 100 is guided by the diverting guide 11 toward the diverted conveyance path, and it is accommodated in the diverting tray 14 by the diverting roller 12.

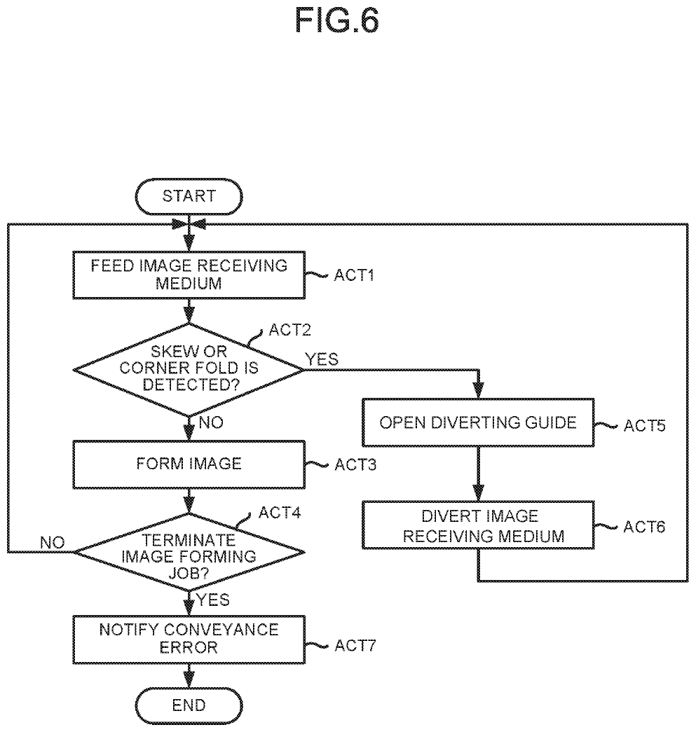

Next, with reference to a flowchart shown in FIG. 6, the image formation including the diverting operation of the image receiving medium having the skew or the corner fold in the image forming apparatus is described. In the following description, the conveyance of the image receiving medium is mainly described.

First, with the operation section 27 of the image forming apparatus 1, a setting operation for forming an image is performed and an image forming job is started. The controller 22 receives an instruction to start the image forming job and sends designated image data to the image forming section 23. The controller 22 receives a signal from the image forming section 23 indicating that preparation for image formation is completed, picks up the image receiving medium 100 from any one of the media cassettes 7 with the pickup roller 8, and feeds the image receiving medium 100 to the conveyance roller 10 with the feed roller 9 (Act 1).

The image receiving medium 100 is then conveyed by the conveyance roller 10 in the conveyance route and the leading edge of the image receiving medium 100 covers the skew sensor 13. Based on the time difference of the receipt of the detection signals from the individual skew sensors of the skew sensor 13, the controller 22 determines whether or not the image receiving medium 100 is skewed or folded at the corner thereof (Act 2). If it is determined that the image receiving medium 100 is in a normal state without being skewed or folded at the corner (NO) at the determination of the skew or the corner fold, an image formation is performed on the image receiving medium 100 (Act 3). In the image formation operation, an image to be transferred onto the intermediate transfer belt 4 is first formed by the image forming section 23. The intermediate transfer belt 4 is pressed against the image receiving medium 100 to transfer the image onto the image receiving medium 100. Furthermore, the image is fixed to the image receiving medium 100 by the fixing unit 3, and the image is formed on the image receiving medium 100.

Next, the controller 22 determines whether or not the image forming job is terminated, for example, whether the number of images to be formed or the number of the image receiving media set before the start is reached (Act 4). If the set number of images of the image receiving media is not reached and the image forming job is not terminated (NO), the flow returns to the process in Act 1, and a new image receiving medium 100 is picked up from the media cassette 7 to be fed to the conveyance roller 10.

In the determination in Act 2 described above, if it is determined that the image receiving medium 100 is skewed or folded at the corner (YES), the controller 22 controls the diverting guide 11 to swing to thereby open it (Act 5). Specifically, the controller 22 controls the diverting guide 11 to swing to insert the tip of the guide 11 into the conveyance route, and the guide 11 guides the image receiving medium 100 conveyed by the conveyance roller 10 toward the diverting route. The controller 22 drives the diverting roller 12 to convey the image receiving medium 100 guided by the diverting guide 11 into the diverting tray 14 (Act 6). Next, after the image receiving medium 100 is accommodated in the diverting tray 14, the controller 22 returns to the process in Act 1, picks up the next image receiving medium 100 from the media cassette 7 to feed it to the conveyance roller 10.

Furthermore, in the termination determination of the image formation job in Act 4 described above, if the set number of images of the image receiving media is reached (YES), if there is just one diverted image receiving medium 100 in this image forming job, the controller 22 notifies an operator or an administrator that the occurrence of the conveyance error through display on a screen on a liquid crystal display or the like for setting an input setting of the image forming apparatus (Act 7), and terminates a series of image forming jobs. In this notification, causes and countermeasures of the conveyance error set in advance on the apparatus side may be displayed on the screen of the display section 26. For example, an instruction to confirm a position of the guide of the media cassette 7 or the like may be displayed on the screen of the display section 26. If the image forming job is terminated without an error such as the conveyance error or the like, it may be displayed that the image forming job is terminated normally on the screen of the display section 26.

As described above, in the image forming apparatus of the present embodiment, with the diverting mechanism 25 having a simple configuration, the skew and the corner fold of the image receiving medium 100 at the initial stage of conveyance can be detected and then the image receiving medium 100 can be diverted from the conveyance route. The registration roller 6 has a function of correcting the skew of the image receiving medium 100. Therefore, in the present embodiment, by arranging the diverting mechanism 25 on the upstream side of the registration roller 6 in the conveyance route, the image receiving medium 100 in the skew state which cannot be corrected by the registration roller 6 is branched to the diverting route to be diverted onto the diverting tray 14.

Therefore, at the initial stage of conveyance of the image receiving medium 100, if the skew of the image receiving medium 100 is determined and the skew of the image receiving medium 100 can be corrected, the image receiving medium 100 is conveyed as it is to the conveyance route side and an image can be formed at an appropriate position. On the contrary, if the skew of the image receiving medium 100 cannot be corrected, the image receiving medium 100 is branched to the diverting route from the conveyance route at a branch point on the upstream side of the registration roller 6 in the conveyance route to be accommodated, thereby reducing the occurrence of jams in the conveyance route before and after the image forming section 23. Therefore, maintenance time (in particular, standby preparation time of the image forming section 23) including a restoration process of the jam can be reduced, and an operation rate can be increased. Due to the reduction in the occurrence of the jam, the damage in a device or apart inside the apparatus due to clogging or pinching of the image receiving medium 100 is reduced. Furthermore, it is possible to recover the skew image receiving medium 100 before the occurrence of the jam and recover the skew image receiving medium 100 without wrinkling or folding it. The recovered image receiving medium 100 can be returned from the diverting tray 14 to the media cassette 7 to be used again for image formation.

### Modification of First Embodiment

The modification of the first embodiment is described below.

FIG. 2B is a diagram conceptually illustrating a diverting mechanism for the image receiving medium according to the modification.

The modification is an example in which three skew sensors 13 (e.g., 13F, 13R and 13C) are arranged while an example in which the two skew sensors 13F and 13R are used is descried in the first embodiment described above.

If the corner fold on the leading edge of the image receiving medium 100 is to be detected, three skew sensors 13 including the skew sensors 13F and 13R on the front side and the rear side and a skew sensor 13C at a center position of the skew sensors 13F and 13 is preferably used. The controller 22 can determine that the corner fold occurs in the image receiving medium 100 if a time at which the skew sensor 13C arranged at the center detects the image receiving medium 100 is the same as a time at which either one of the skew sensors 13F and 13R detects the image receiving medium 100, it can be determined that the corner fold occurs in the image receiving medium 100. If all the detection times of the skew sensors 13F, 13R and 13C are different, it can be determined that the image receiving medium 100 is skewed. However, it cannot be determined whether or not there is the corner fold.

Therefore, in a case in which all the detection times of the three skew sensors 13 are different from each other, if the three detection times can be connected linearly by a arithmetic process, it is determined that the image receiving medium is skewed. If the three detection times are bent at the center and connected with two lines by the arithmetic process, it can be determined that there is a corner fold in the image receiving medium, or the image receiving medium is skewed and folded at the corner.

The controller 22 calculates a value (for example, angle) of an inclination of the image receiving medium 100 obtained from the time difference ΔT and a conveyance speed. The controller 22 diverts the image receiving medium 100 to the diverting tray 14 if the value of the inclination of the image receiving medium 100 exceeds a known value of the inclination that can be corrected by the registration roller 6. Conversely, if the value of the inclination of the image receiving medium 100 is less than or equal to the known value of the inclination that can be corrected by the registration roller 6, the image receiving medium 100 is not fetched into the diverting tray 14, but is conveyed to the registration roller 6 as it is. If the controller 22 determines that the corner fold occurs in the image receiving medium 100, regardless of the calculated value of the inclination of the image receiving medium 100, the controller 22 diverts the image receiving medium 100 to the diverting tray 14.

In this modification, it is possible to distinguish the skew and the corner fold of the image receiving medium 100 separately. Furthermore, depending on an angle of the skew of the image receiving medium 100, it is possible to determine whether to divert it to the diverting tray 14 or to convey it to the registration roller 6. Therefore, if it is the image receiving medium 100 whose inclination can be corrected, it can be conveyed as it is in the conveyance route, and the image formation can be performed by correcting the inclination thereof. In the modification, it is possible to divert all the image receiving media 100 determined to be folded at the corner in the diverting tray. Therefore, it is possible to selectively divert the image receiving medium 100 which is skewed or folded at the corner, thereby efficiently preventing the conveyance error due to the jam and performing the image formation.

In particular, it is effective also when reusing the image receiving medium on only one surface of which an image is recorded. In the reused image receiving medium 100, there is a case in which thermal deformation occurs at the time of the previous image recording, or the image receiving medium 100 on which the fold already occurs due to browsing is contained. If trying to reuse the image receiving medium 100 with these defects, the probability and frequency of the occurrence of the jam increase. Therefore, in the present embodiment, since the determination of fold is also performed immediately after the reused image receiving medium 100 is picked up from the media cassette 7, it is possible to guide the image receiving medium 100 to the diverting route before the occurrence of the jam.

### Second Embodiment

Next, the image forming apparatus according to the second embodiment is described.

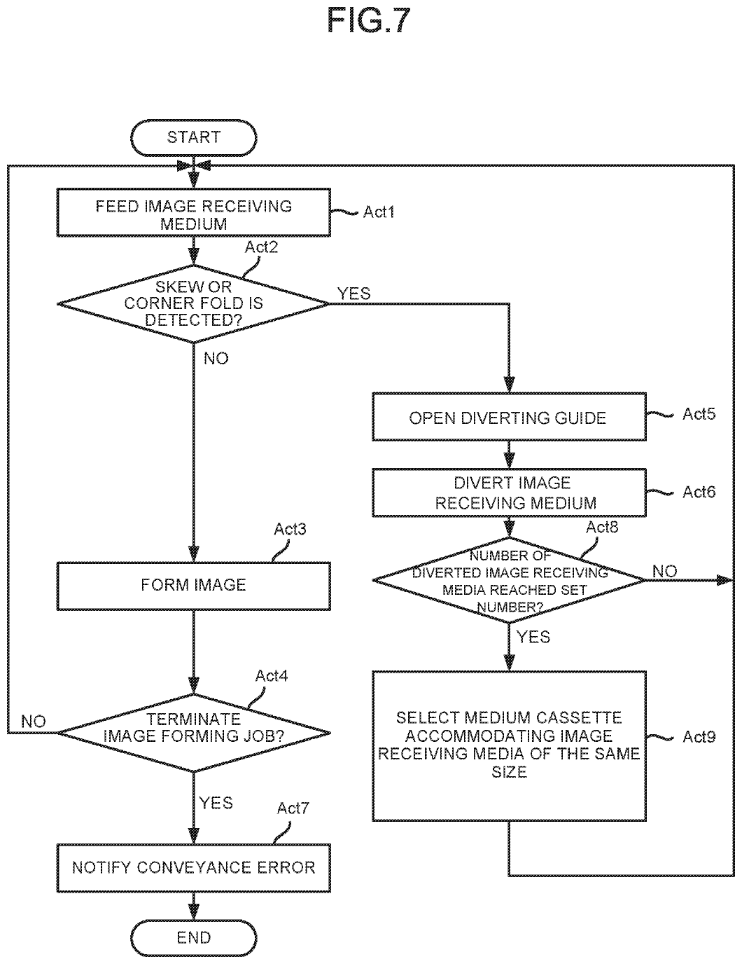

FIG. 7 is a flowchart for depicting an image forming example including the diverting operation of the image receiving medium in the image forming apparatus according to the second embodiment. The second embodiment is different from the above-described first embodiment in the diverting operation of the image receiving medium, but has the same components as the first embodiment, as the same reference numerals and the same step numbers are denoted thereto, the description thereof is omitted.

In the present embodiment, when the skew of the image receiving medium 100 is continuously detected by the skew sensor 13, or when the preset number of the image receiving media is diverted into the diverting tray continuously, a media cassette accommodating the image receiving medium of the same size is switched to, and the image receiving medium is picked up from the switched to media cassette to continue the image forming job.

Here, as an example, the image receiving media 100 of the same size are loaded in the media cassettes 7a and 7b respectively. It is assumed that the guide in the media cassette 7a is not arranged at a defined position and there is a gap between the guide and the image receiving medium. The guide in the media cassette 7b is set to the defined position and there is no gap between the guide and the image receiving medium 100. Since the pickup roller 8 continuously picks up the image receiving medium 100 under the same condition, if the gap acts, the same skew state continuously occurs in the image receiving medium 100.

The flow of the image formation according to the present embodiment differs from that in the first embodiment in that the processes after the skew of the image receiving medium is detected and the image receiving medium is diverted are different. In the present embodiment, the media cassette loaded with the image receiving medium of the same size is switched to, and the image formation is continued.

First, with the operation section 27 of the image forming apparatus 1, a setting operation for continuously forming images on a plurality of the image receiving media is performed, and the image forming job is started. The controller 22 enables the image forming section 23 to prepare for the image formation, receives a signal of preparation completion, picks up the image receiving medium 100 from the media cassette 7a by the pickup roller 8a and the first feed roller 9a, and then feeds it to the conveyance roller 10 (Act 1).

Next, the image receiving medium 100 is conveyed by the conveyance roller 10, and the leading edge of the medium covers the skew sensor 13. Based on the detection signals from the skew sensor 13, the controller 22 determines whether or not the image receiving medium 100 is skewed or whether there is a corner fold in the image receiving medium 100 (Act 2). At the determination in Act 2, if it is determined that the image receiving medium 100 is in a normal state without being skew or folded at the corner (NO), the image formation is performed on the image receiving medium 100 (Act 3).

Next, the controller 22 determines whether or not the image forming job is finished, i.e., whether or not the number of the image receiving media 100 set before the start is reached (Act 4). If the set number of the image receiving medium is not reached, and the image forming job is not terminated (NO), the flow returns to the process in Act 1, and a new image receiving medium 100 is picked up from the media cassette 7 to be fed from the feed roller 9b to the conveyance roller 10.

If it is determined that the image receiving medium 100 is skewed or folded at the corner (YES) in the determination in Act 2 described above, the controller 22 opens the diverting guide 11 (Act 5). Specifically, the controller 22 controls the diverting guide 11 to swing, inserts the tip of the guide into the conveyance route, and guides the image receiving medium 100 conveyed by the conveyance roller 10 toward the diverting route. The controller 22 drives the diverting roller 12 to convey the image receiving medium 100 onto the diverting tray 14 (Act 6).

Next, the controller 22 determines whether or not the number of the image receiving media 100 diverted onto the diverting tray 14 in one image forming job reaches a preset diversion number (Act 8). If the number of diverted image receiving media 100 does not reach the set number (NO), the flow returns to the process in Act 1, and the next image receiving medium 100 is picked up from the media cassette 7a to be fed to the conveyance roller 10. On the other hand, if the number of diverted image receiving media 100 reaches the set number (YES), it is assumed that the skew state of the image receiving medium 100 picked up is kept thereafter, the media cassette 7b loading the same image receiving medium 100 is selected, and the image receiving medium 100 is picked up by the pickup roller 8b and the second feed roller 9b (Act 9).

In the termination determination of the image forming job in Act 4 described above, if the number of the image receiving media 100 subjected to the image formation reaches the set number (YES), the controller 22 notifies the operator and the administrator of the occurrence of the conveyance error is notified through the display (Act 7), and then terminates a series of image forming jobs. For example, even if there is only one diverted image receiving medium 100 in the image forming job, the presence of the diverted image receiving medium 100 is displayed on the screen of the display section 26 in this notification. In this notification, the number of the diverted image receiving media 100, and causes and countermeasures of the conveyance error may be displayed on the screen of the display section 26. For example, an instruction to confirm a position of the guide of the media cassette 7a may be displayed on the screen of the display section 26. If the image forming job is terminated without an error such as the conveyance error or the like, it may be displayed that the image forming job is terminated normally on the screen of the display section 26.

As described above, in addition to the effect of the above-described first embodiment, the image forming apparatus of the present embodiment can continue the image forming job even when the skew state of the image receiving medium 100 is kept. If the number of the image receiving media 100 diverted to the diverting tray 14 due to the skew state of the image receiving media 100 in one image forming job reaches the set number, another media cassette accommodating the image receiving media 100 having the same size is switched to, and the image forming job can be continuously performed.

If the occurrence of skew in the image receiving medium 100 is caused by the gap between the guide in the media cassette and the image receiving medium, unless the guide is set at the proper position, the skew state cannot be corrected during operation. Therefore, even if the image forming job is in progress, it must be temporarily stopped to confirm the position of the guide in the media cassette. On the other hand, in the present embodiment, when the preset number of the diverted image receiving media 100 is exceeded, as another media cassette is switched to continue the image forming job, it is possible to terminate one image forming job without interrupting the image forming job.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image forming section configured to form an image on an image receiving medium that is conveyed along a conveyance path from a cassette to the image forming section;
a diverted conveyance path connected to the conveyance path at a first point on the conveyance path that is upstream of the image forming section;
a movable guide that is controlled to guide the image receiving medium along a first path that includes a second point on the conveyance path that is downstream of the first point on the conveyance path or a second path that includes the diverted conveyance path;
three sensors positioned to detect at least three positions of a leading edge of the image receiving medium before the image receiving medium is guided by the movable guide, the three sensors being aligned along a width direction of the conveyance path;
a controller configured to determine an amount of skew of the image receiving medium when leading edge detection times are different for all of the three sensors, and control the movable guide to guide the image receiving medium along the second path when the determined amount of skew is greater than a threshold amount; and
a registration roller disposed downstream of the first point along the conveyance path, and configured to correct a skew of an image receiving medium less than the threshold amount.

2. The image forming apparatus according to claim 1, wherein
the controller is further configured to control the movable guide to guide the image receiving medium along the first path when the determined amount of skew is less than the threshold amount.

3. The image forming apparatus according to claim 1, wherein
the controller is further configured to determine that the image receiving medium has a fold when the leading edge detection times are the same for two of the three sensors and different for one of the three sensors, and control the movable guide to guide the image receiving medium having the fold along the second path.

4. The image forming apparatus according to claim 1, wherein
the cassette has an alignment guide that is movable to set an orientation of the image receiving medium to be picked up from the cassette onto the conveyance path.

5. The image forming apparatus according to claim 1, wherein the diverted conveyance path leads to a diverting tray, and not to the image forming section.

6. The image forming apparatus according to claim 1, wherein the registration roller is disposed upstream of the image forming section.

7. The image forming apparatus according to claim 1, wherein the controller is configured to determine that leading edge detection times of two of the three sensors are different when a difference of the leading edge detection times of two of the three sensors is greater than a threshold.

8. An image forming apparatus comprising:
first and second cassettes each configured to accommodate a plurality of image receiving media having the same size;
an image forming section configured to form an image on an image receiving medium that is conveyed along a conveyance path from one of the first and second cassettes to the image forming section;
a diverted conveyance path connected to the conveyance path at a first point on the conveyance path that is upstream of the image forming section;
a movable guide that is controlled to guide the image receiving medium along a first path that includes a second point on the conveyance path that is downstream of the first point on the conveyance path or a second path that includes the diverted conveyance path;
three sensors positioned to detect at least three positions of a leading edge of the image receiving medium before the image receiving medium is guided by the movable guide, the three sensors being aligned along a width direction of the conveyance path;
a controller configured to determine an amount of skew of the image receiving medium when leading edge detection times are different for all of the three sensors, and control the movable guide to guide the image receiving medium along the second path when the determined amount of skew is greater than a threshold amount; and
a registration roller disposed downstream of the first point along the conveyance path, and configured to correct a skew of an image receiving medium less than the threshold amount.

9. The image forming apparatus according to claim 8, wherein
the controller is further configured to control the movable guide to guide the image receiving medium along the first path when the determined amount of skew is less than the threshold amount.

10. The image forming apparatus according to claim 8, wherein
the controller is further configured to determine that the image receiving medium has a fold when the leading edge detection times are the same for two of the three sensors and different for one of the three sensors, and control the movable guide to guide the image receiving medium having the fold along the second path.

11. The image forming apparatus according to claim 8, wherein each of the first and second cassettes has an alignment guide that is movable to set an orientation of the image receiving medium to be picked up from the cassette onto the conveyance path.

12. The image forming apparatus according to claim 8, wherein the diverted conveyance path leads to a diverting tray, and not to the image forming section.

13. The image forming apparatus according to claim 8, wherein the registration roller is disposed upstream of the image forming section.

14. The image forming apparatus according to claim 8, wherein the controller is configured to determine that leading edge detection times of two of the three sensors are different when a difference of the leading edge detection times of two of the three sensors is greater than a threshold.

15. A method of diverting an image receiving medium that is conveyed along a first path from a cassette to an image forming section to a second path that is branched from the first path at a first point along the first path that is upstream of the image forming section, said method comprising:
detecting at least three positions of a leading edge of the image receiving medium using at least three sensors aligned along a width direction of the conveyance path, before the image receiving medium reaches the first point;
determining an amount of skew of the image receiving medium when leading edge detection times are different for all of the three sensors;
diverting the image receiving medium from the first path to the second path when the amount of skew of the image receiving medium is greater than a threshold amount; and
correcting the skew of the image receiving medium at a second point along the first path that is downstream of the first point and upstream of the image forming section when the amount of skew is less than the threshold amount.

16. The method according to claim 15, wherein the skew of the image receiving medium is corrected at the second point using a registration roller.

17. The method according to claim 15, further comprising:
detecting that the leading edge detection times are the same for two of the three sensors and different for one of the three sensors;
diverting the image receiving medium from the first path to the second path when detecting that the leading edge detection times are the same for two of the three sensors and different for one of the three sensors.

18. The method according to claim 5 wherein the cassette has an alignment guide that is movable to set an orientation of the image receiving medium to be picked up from the cassette onto the first path.

19. The method according to claim 15, wherein the second path leads to a diverting tray, and not to the image forming section.

20. The method according to claim 15, wherein leading edge detection times of two of the three sensors are determined to be different when a difference of the leading edge detection times of two of the three sensors is greater than a threshold.
